(19) United States
(12) Patent Application Publication
(10) Pub. No.: US 2024/0175219 A1
(43) Pub. Date: May 30, 2024

(54) ROAD CONSTRUCTION MACHINE AND PAVING TRAIN WITH ROAD CONSTRUCTION MACHINE AND MOBILE SUPPLY MACHINE

(71) Applicant: JOSEPH VOEGELE AG, Ludwigshafen/Rhein (DE)

(72) Inventor: Daniel DRAXLER, Schriesheim (DE)

(73) Assignee: JOSEPH VOEGELE AG, Ludwigshafen/Rhein (DE)

(21) Appl. No.: 18/524,207

(22) Filed: Nov. 30, 2023

(30) Foreign Application Priority Data
Nov. 30, 2022 (EP) 22210411.9

(51) Int. Cl. E01C 19/48; B60D 1/64; B60D 3/00

(52) U.S. Cl. CPC E01C 19/4873; B60D 1/64; B60D 3/00; E01C 2301/04; E01C 2301/08

(57) ABSTRACT

The disclosure relates to a road construction machine in the form of a road finisher or a feeder vehicle for conveying paving material to a road finisher. The road construction machine is self-propelled and has a primary drive, a material hopper, at least one electrical load, at least one energy storage, and at least one interface which is connectable to a mobile supply machine for energy transmission or energy resources transmission.

### CROSS-REFERENCE TO RELATED APPLICATIONS

This application claims foreign priority benefits under 35 U.S.C. § 119(a)-(d) to European patent application number EP 22210411.9, filed Nov. 30, 2022, which is hereby incorporated by reference herein in its entirety.

### TECHNICAL FIELD

The disclosure relates to a road construction machine in the form of a road finisher or a feeder for conveying paving material to a road finisher and to a paving train comprising a road construction machine and a mobile supply machine, a method for operating the paving train and a use of an interface of a road construction machine.

### BACKGROUND

A road finisher of this type is known from EP 1 118 714 B1 and a feeder of this type is known from EP 2 110 341 A1.

Conventional road construction machines usually use diesel fuel as their energy source. The chemical energy of the diesel fuel is converted into mechanical energy via a diesel motor, which is used to operate actuators. The actuators then usually feed rotational movements or translational movements. The road construction machine then uses these movements to carry out its work and subtasks. For a road finisher, this would be, for example, driving, steering, conveying material, distributing material, leveling, compacting material. For a feeder vehicle, this would be, for example, driving, steering, conveying material. Rotational movements are implemented using hydraulic motors, for example, while translational movements are implemented using hydraulic cylinders, for example. For the screed heating of a road finisher, mechanical energy is converted into electrical power via a generator, which is then converted into heat. The disadvantage of this drive mechanism is the use of fossil fuels (e.g. diesel fuel) and the associated exhaust emissions.

On the other hand, the shorter range of the paving train is a problem for electrified road construction machines. Current road finishers with diesel tanks are designed so that they can be powered for around 10 hours on one tank of fuel and achieve a certain range. This assumes a high to maximum utilization of the road finisher. When using an energy storage system for an electrified road finisher, such as an accumulator (rechargeable battery) or a battery as an energy source and electric drive trains, significantly larger and heavier energy storage systems would have to be used to achieve similar ranges, due to the lower energy density of an accumulator compared to the energy density of diesel fuel. As this can only be realized to a limited extent without drastically increasing the size of the road finisher, the result is a significant reduction in the working time or amount of work that a road finisher can perform with one energy storage charge. The battery would therefore have to be replaced or recharged one or more times due to the shorter range of an electrified road finisher with a battery as an energy source. Alternatively, the road finisher with the empty battery would have to be driven away from the construction site so that another road finisher with a charged battery can be used as a replacement. Consequently, the construction site would have to be interrupted for a short or longer period of time. Interrupting the construction site is not only detrimental to energy efficiency (e.g., the screed and material conveyors have to be warmed up again after the interruption), but also to paving quality. This is because interruptions can potentially lead to start-up marks, segregation, temperature drops in the mixed material, compaction problems and even cooling and solidification of the paving material in the road finisher.

The present disclosure provides a road construction machine, paving train, and/or method to eliminate or at least reduce the above-mentioned disadvantages.

### SUMMARY

The disclosure relates to a road construction machine in the form of a road finisher or a feeder vehicle for conveying paving material to a road finisher, wherein the road construction machine is self-propelled and has a primary drive, a material hopper, at least one electrical load, and at least one energy storage, wherein at least one interface for energy transmission and/or energy resources transmission can be connected to a mobile supply machine. The disclosure allows to create a local construction site on which the road construction machines can be operated using only electrical power or another form of alternative energy. As a result, exhaust emissions on the construction site can be reduced or completely prevented. Such construction sites are particularly desirable in city centers, in tunnels or in buildings. One of the other advantages of the disclosure is an extension of the operating time and range of a moving road construction machine, because the road construction operation does not have to be stopped if the road construction machine runs out of energy and/or energy resources. The disclosure can also reduce interruptions during paving and thus improve paving quality.

The primary drive of the road construction machine can be an electric motor. Electrical power can be transferred from the mobile supply machine to the road construction machine. An energy resource can be an energy carrier. Energy resources can be transferred from the mobile supply machine to the road construction machine. An energy resource can be a liquid required for generating energy for galvanic cells, for example an electrolyte. An energy resource can be a fuel for fuel cells, for example hydrogen. The primary drive of the road construction machine can be a hydrogen combustion engine. Hydrogen as an energy resource can be transferred from the mobile supply machine to the road construction machine. An energy resource may be a fuel such as gasoline or diesel. The primary drive of the road construction machine may be a hybrid drive comprising, for example, an electric motor and a diesel motor. Diesel may be transferred as an energy resource from the mobile supply machine to the road construction machine. The energy storage can be a battery or an accumulator (rechargeable battery) or a lithium-ion accumulator.

The interface of the road construction machine can be connected to a connecting unit of the mobile supply machine. By connecting the interface to the connecting unit, the road construction machine can transmit force to the mobile supply machine. By connecting the interface to the connecting unit, the mobile supply machine can transmit force to the road construction machine. The interface of the road construction machine can be an electromechanical component. The connecting unit of the mobile supply machine can be an electromechanical component. The interface and the connecting unit can be electromechanical units that mate together. The electromechanical component can have at least one mechanical component. The electromechanical component can have at least one current conductor. The outside of the electromechanical component can be at least partially covered with an insulating sheath. By connecting the interface of the road construction machine and the connecting unit of the mobile supply machine, an electrical circuit can be closed or disconnected. The electromechanical component can have a male part or a plug. The electromechanical component can have a female part, or a socket. The road construction machine interface may have a locking mechanism to mechanically secure the interface and the connecting unit together, at least during energy transmission and/or energy resources transmission. The connecting unit of the mobile supply machine may have a locking mechanism to mechanically secure the connecting unit and the interface to each other at least during energy transmission and/or energy resources transmission.

The road construction machine can be loaded with paving material by the mobile supply machine. The material hopper of the road construction machine can be at least partially filled with paving material supplied by the mobile supply machine. The mobile supply machine can, for example, be a material supply vehicle or a delivery truck. The mobile supply machine can have a material dump or a receptacle, such as a tiltable storage hopper, to transport paving material to the road construction machine. The advantage of this is the mobility of the delivery truck outside the construction site and its interchangeability within the construction site without having to interrupt the construction process. Using a delivery truck as a mobile supply machine can also create the following advantages. A delivery truck can shuttle between a construction site and a mixing plant and, for example, a power charging station (it is also possible that a power charging station is present at the mixing plant), while the road construction machine or road finisher continuously paves material or a feeder vehicle continuously transports paving material to the road finisher. This allows the road construction machine to be loaded with paving material while the road paver is being electrically charged. The mobile supply machine can have an electric motor and at least one rechargeable and replaceable energy storage, so that the road construction site is free of exhaust emissions. The energy storage can be a battery or an accumulator (rechargeable battery) or a lithium-ion accumulator or a capacitor. Furthermore, the mobile supply machine can supply the road construction machine with pre-heated paving material. It is conceivable that the paving material is already heated in the mobile supply machine, for example during a journey between a mixing plant and the construction site, such as to a temperature of between 30° ° C. and 250° C., and furthermore such as to a temperature of between 60° C. and 120° C.

In a variant of the disclosure, the road construction machine has a first interface. The road construction machine can be connected to the mobile supply machine, or to a first connecting unit of the mobile supply machine, via the first interface for transmitting electrical power. The road construction machine can dock onto the mobile supply machine or vice versa via the first interface. The road construction machine can be mechanically and/or electrically connected to the mobile supply machine via the first interface. The road construction machine can push the mobile supply machine through the mechanical connection in one direction of travel, for example in the direction of installation. During a common journey of the road construction machine with the mobile supply machine, paving material and energy or electrical power can be transported from the mobile supply machine to the road construction machine. An electrical circuit can be connected to the first interface. An electrical line connected to the first interface may be connected to the energy storage and/or to one of the electrical loads. The electrical line can be fed under the material hopper to the energy storage or to one of the electrical loads in an insulating hose.

In a variant of the disclosure, the road construction machine has a second interface for transferring energy resources, such as fuel, diesel, natural gas, hydrogen or liquids required to operate the galvanic cells, which can be connected to the mobile supply machine or to a second connecting unit of the mobile supply machine. The road construction machine can dock onto the mobile supply machine or vice versa via the second interface. The road construction machine can be mechanically and electrically connected to the mobile supply machine via the second interface. The road construction machine can push the mobile supply machine through the mechanical connection in one direction of travel, for example in the direction of installation. During a common journey of the road construction machine with the mobile supply machine, paving material and energy resources can be transported from the mobile supply machine to the road construction machine. Energy resources, such as from an energy resource tank of the mobile supply machine to an energy resource tank of the road construction machine, can be transferred via the second interface of the mobile supply machine. The energy resources can be transferred via a pipeline or a corrosion-resistant pipeline. One of the inputs of the pipeline may be connected to the second interface and one of the inputs may be connected to the second connecting unit. The pipeline can lead to an energy resources tank under the material hopper.

Advantageously, the first interface and/or the second interface are arranged at a docking end of the road construction machine. Thus, the first interface and/or the second interface can be connected to a connecting unit arranged on a docking side of the chassis of the mobile supply machine, so that the road construction machine can move the mobile supply machine during the construction of a road surface. Advantageously, the construction of the road surface can be carried out without interruption while the road construction machine is continuously paving material and is supplied with electrical power and/or energy resources and/or paving material by the mobile supply machine.

The first interface and/or the second interface are arranged on a pushing device of the road construction machine. The pushing device may comprise at least one or more push rollers. The push rollers may be arranged on a chassis component, such as a cross beam, which is arranged on the road construction machine. The pushing device may be movably mounted by means of a spring-damper unit. The first interface and/or the second interface can be arranged between two rotatably mounted push rollers. When the push rollers dock onto the tires of the mobile supply machine, the tires can deform elastically. This can prevent installation errors in the road surface.

Advantageously, the road construction machine can be mechanically connected to the mobile supply machine via the first interface and/or via the second interface, so that the road construction machine can transmit force to the mobile supply machine.

Expediently, the first interface and/or the second interface each have an opening for receiving a connecting unit of the mobile supply machine.

Expediently, the first interface has at least one first opening, wherein the first opening is suitable for receiving a first connecting unit of the mobile supply machine. The first interface may have a plurality of contact openings. The first connecting unit may comprise a pin header receivable in at least the first opening. The first connecting unit may extend from a chassis of the mobile supply machine in a direction of travel of the mobile supply machine. The first interface may be in the form of an attachment jaw. The first connecting unit may be formed as a spacer bar.

Expediently, the second interface has at least one second opening, wherein the second opening is suitable for receiving a first connecting unit of the mobile supply machine. The second connecting unit can extend from a chassis of the mobile supply machine in a direction of travel of the mobile supply machine. The second interface may be formed as an attachment mouth with a pipe opening. The second connecting unit may be formed as a spacer bar with a pipe opening.

Advantageously, the energy storage can be at least partially charged with electrical power transmitted by the mobile supply machine. The mobile supply machine can transfer an energy of 0.5 kWh to 25 kWh, an energy of 1 kWh to 10 kWh, or an energy of 2 kWh to 5 kWh to the road construction machine in a predetermined period of time.

Advantageously, the primary drive of the road construction machine can be supplied directly with electrical power transmitted by the mobile supply machine. For this purpose, a power supply path can electrically connect the first interface directly to the primary drive of the road construction machine.

The road construction machine may have a control system. The control system may be configured to monitor an (electrical) charge level of the energy storage of the road construction machine. The control system may be configured to initiate a transfer of electrical power from the mobile supply machine to the road construction machine when the charge level is between twenty percent and ninety percent or between thirty percent and eighty percent. The control system may have a charge controller. The charge controller may be connected to the energy storage system.

The disclosure further relates to a paving train comprising at least one road construction machine in the form of a road finisher or a feeder vehicle for conveying paving material to a road finisher, wherein the road construction machine is self-propelled and has a primary drive, a material hopper, at least one electrical load, at least one energy storage and at least one interface, wherein the paving train has a mobile supply machine with at least one connecting unit, wherein the interface of the road construction machine can be connected to the connecting unit of the road supply machine for energy transmission and/or energy resources transmission. The paving train can be for creating a road surface. The paving train may comprise a road finisher and a mobile supply machine preceding the road finisher. The paving train can have a road finisher and a feeder vehicle driving ahead of the road finisher and a mobile supply machine driving ahead of the feeder vehicle.

Advantageously, the interface and the connecting unit are electromechanical components that mate together.

Advantageously, the mobile supply machine is a material supply vehicle, in particular a material supply vehicle for delivering paving material, e.g., a delivery truck. The mobile supply machine can have a material dump or receptacle, such as a tiltable storage hopper, for transporting paving material to the road construction machine. The mobility of the delivery truck outside the construction site and its interchangeability within the construction site can be advantageous. A delivery truck can commute between a construction site and a mixing plant and, for example, an electric charging station (it is also possible that an electric charging station is present at the mixing plant), while the road construction machine continuously paves material. The electrically charged delivery truck can connect to the road construction machine on the construction site and transfer paving material to the material hopper. The delivery truck can then drive away from the construction site to be recharged and/or refueled. The paving train's mobile supply machine can be interchangeable. It is possible that several mobile supply machines are available on the construction site to ensure uninterrupted construction work. It is possible for the mobile supply machines to be driven outside the construction site by means of an internal combustion engine or hybrid engine.

Advantageously, the mobile supply machine is a material supply vehicle, in particular a material supply vehicle for delivering paving material, e.g. a delivery truck.

Expediently, a first interface and a first connecting unit can be connected to each other for the transmission of electrical power.

Expediently, a second interface and a second connecting unit can be connected to each other for the transfer of energy resources, such as fuel, diesel, natural gas, hydrogen or liquids required to operate the galvanic cells.

Advantageously, a primary drive of the mobile supply machine can be an electric motor, a hydrogen engine, an internal combustion engine or a fuel cell or a hydrogen combustion engine. The primary drive can be a hybrid drive comprising at least two of the aforementioned different drives.

Advantageously, the first interface and/or the second interface are arranged at a docking end of the road construction machine, such as at a pushing device of the road construction machine.

Advantageously, the first connecting unit and/or the second connecting unit are arranged on a docking side of the mobile supply machine.

Advantageously, the first interface and/or the second interface are arranged at a docking end of the road construction machine, such as at a pushing device of the road construction machine. The first interface and/or the second interface can be electromechanical interfaces.

Advantageously, the first connecting unit and/or the second connecting unit are arranged on a docking side of the mobile supply machine. The first connecting unit and/or the second connecting unit can be electromechanical interfaces.

In one variant of the disclosure, an energy storage of the mobile supply machine is interchangeable with or against the energy storage of the road construction machine. The mobile supply machine can have at least one energy storage, such as two energy storages, or three to five energy storages, which in particular can be individually interchangeable. A module with several energy storages of the mobile supply machine can be installed on a passenger seat on a chassis or on a chassis of the mobile supply machine. The energy storages of the mobile supply machine can be installed individually on a free passenger seat.

The interface of the road construction machine and the connecting unit of the mobile supply machine are suitable for electromechanical coupling with each other.

Advantageously, the mobile supply machine can be displaced by the road construction machine in a direction of travel of the paving train, in particular during energy transmission and/or energy resources transmission.

The disclosure further relates to a method for operating a paving train comprising at least one road construction machine in the form of a road finisher or a feeder vehicle for conveying paving material to a road finisher, wherein the road construction machine is self-propelled and has a primary drive, a material hopper, at least one electrical load and at least one energy storage, wherein the paving train comprises a mobile supply machine, such as a mobile supply machine with a material dump for supplying paving material to the road construction machine. The method comprises connecting an interface of the road construction machine to a connecting unit of the mobile supply machine for transferring electrical power and/or energy resources from the mobile supply machine to the road construction machine. The interface may be mechanically connected to the connecting unit. The road construction machine can dock onto the mobile supply machine. The mobile supply machine may be displaced by the road construction machine in a direction of travel of the paving train, in particular during the transfer of electrical power. The method may comprise connecting an interface of the road construction machine to a connecting unit of the mobile supply machine for transferring electrical power and/or paving material from the mobile supply machine to the road construction machine. The method may comprise connecting an interface of the road construction machine to a connecting unit of the mobile supply machine for transferring energy resources and/or paving material from the mobile supply machine to the road construction machine.

The method may comprise the following method steps: monitoring a first charge level of the energy storage of the road construction machine, and transferring electrical power from the mobile supply machine to the road construction machine when the first charge level is between twenty percent and ninety percent, or between thirty percent and eighty percent.

The disclosure further relates to the use of an interface of a road construction machine for an electromechanical coupling with a connecting unit of a mobile supply machine for energy transmission and/or energy resources transmission.

All features and advantages disclosed in connection with the road construction machine can be used individually or together in the paving train, in the method or in the use. All features disclosed in connection with the method may be used individually or together in the road construction machine, in the paving train or in the use. All features disclosed in connection with the paving train can be used individually or together in the road construction machine, in the method or in the use. All features disclosed in connection with the use can be used individually or together in the road construction machine, in the method or in the paving train.

### BRIEF DESCRIPTION OF THE DRAWINGS

In the following, the disclosure shall be explained in more detail by way of embodiments with reference to the figures, of which

FIG. 1 a schematic perspective view of a road construction machine in the form of a road finisher,

FIG. 2 a schematic perspective view of a road construction machine in the form of a feeder vehicle for conveying paving material to a road finisher,

FIG. 3 a schematic perspective view of a mobile supply machine,

FIG. 4 a schematic representation of a paving train comprising the road construction machine and the mobile supply machine,

FIG. 5 a schematic representation of the paving train of FIG. 4 in a docking state,

FIG. 6 a schematic representation of a paving train comprising the road construction machine and the mobile supply machine,

FIG. 7 a schematic representation of the paving train of FIG. 6 in a docking state.

### DETAILED DESCRIPTION

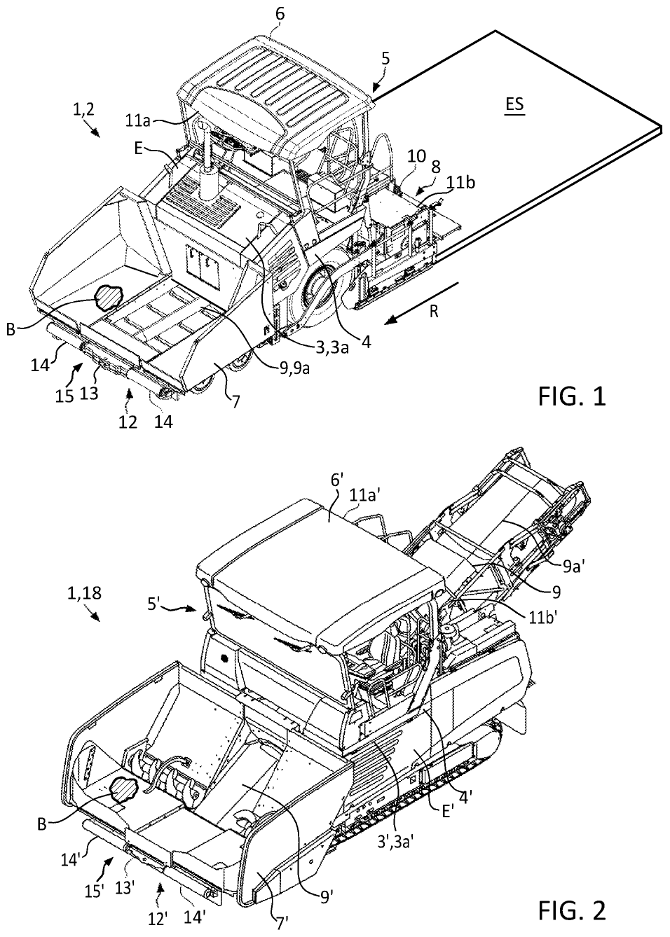

FIG. 1 shows a perspective view from the front of a road construction machine 1, which is a road finisher 2 for producing a road surface ES. The road finisher 2 is self-propelled in a direction of travel R. The road finisher 2 has a primary drive 3. The primary drive 3 of the road finisher 2 is an electric motor 3a. The electric motor 3a is electrically supplied by an energy storage E of the road finisher 2. The road finisher 2 also has a chassis 4, an operator's platform 5, a driver's roof 6, a material hopper 7 for holding a paving material B (asphalt mix), a paving screed 8 mounted on the chassis 4 so as to be adjustable in height and towed in a direction of travel R, and a conveyor unit 9 comprising a conveyor belt 9a for making the paving material B from the material hopper 7 of the road finisher 2 available to the paving screed 8 by means of a transverse distributor device 10 of the road construction machine 1.

The road finisher 2 has at least one electrical load 11. A first electrical load 11a is a light for illuminating the surroundings or the control stand 5. A second electrical load 11b is a heater for heating the paving screed 8. The paving screed 8 comprises components such as compacting units (screed plates, tamper and pressure bars (not shown)). The paving material B is compacted by the action of the compaction unit's own weight. To prevent the paving material B from sticking to the components of the paving screed 8, heating devices (not shown) can be integrated into these components.

The road finisher 2 comprises a pushing device 12 for smooth docking, e.g., to a material supply vehicle (not shown in FIG. 1). A coupling device 13 is provided on the central section of the pushing device 12, which can be connected directly to a material supply vehicle not shown. In addition, docking elements 14 are arranged on the pushing device 12. The docking elements 14 are provided as rotatably mounted push rollers. The docking elements 14 come into contact with an approaching material supply vehicle, for example, during docking end and enable the material supply vehicle to be pushed forward smoothly.

A (first) interface 15 is provided on the coupling device 13. The interface 15 is an electromechanical unit that is suitable for electrical energy transmission and for mechanical coupling, which may comprise an electrically conductive socket configured to receive an electrically conductive plug.

FIG. 2 shows a perspective view from the front of a road construction machine 1, which is a feeder vehicle 18 for conveying paving material B to a road finisher 2 traveling behind it. The feeder vehicle 18 is self-propelled and comprises a primary drive 3′. The primary drive 3′ of the road construction machine 1 is an electric motor 3a′. The electric motor 3a′ is electrically supplied by an energy storage E′, of the feeder vehicle 18. The feeder vehicle 18 comprises a chassis 4′, an operator's platform 5′, a driver's roof 6′, a material hopper 7′ for receiving the paving material B, and a conveyor unit 9′ comprising a conveyor belt 9a′ for transporting the paving material B′ from the material hopper 7′ of the feeder vehicle 18 into the material hopper 7′ of the road finisher 2.

The feeder vehicle 18 has at least one electrical load 11′. A first electrical load 11a′ is a lighting device for illuminating the surroundings or the control stand 5′. A second electrical load 11b′ is a heating device for heating the conveyor belt 9a′.

The feeder vehicle 18 comprises a pushing device 12′ for smooth docking, for example to a material supply vehicle (not shown in FIG. 2). A coupling device 13′ is provided on the central section of the pushing device 12′, which can be connected directly to a material supply vehicle not shown. In addition, docking elements 14′ are arranged on the pushing device 12′. The docking elements 14′ are provided as rotatably mounted push rollers. The docking elements 14′ come into contact with an approaching material supply vehicle, for example, during docking end and enable the material supply vehicle to be pushed forward smoothly.

An interface 15′ is provided on the coupling device 13′. The interface 15′ is an electromechanical unit that is suitable for electrical energy transmission and for mechanical coupling, which may comprise an electrically conductive socket configured to receive an electrically conductive plug.

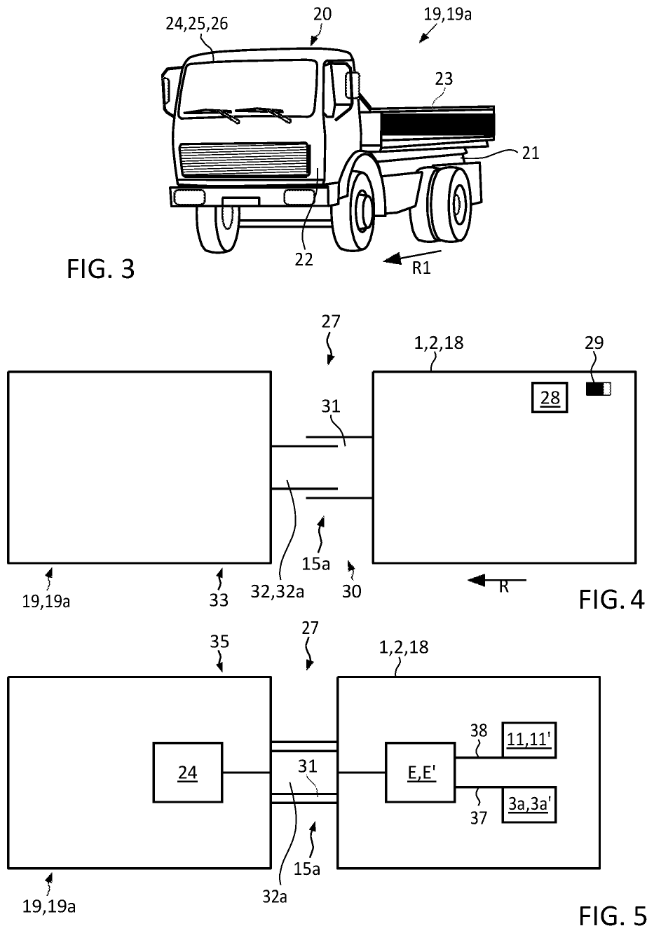

FIG. 3 shows a schematic perspective view of a mobile supply machine 19 or a material supply vehicle 19a in the form of a truck or a tipper truck or dump truck. The mobile supply machine 19 is self-propelled. The mobile supply machine 19 comprises a driver's control station 20 as well as a chassis 21 and a primary drive 22. The primary drive 22 can be an electric motor, a hydrogen engine, an internal combustion engine or a fuel cell or a hydrogen combustion engine. The primary drive 22 may be a hybrid drive comprising at least two of the aforementioned different drives. The mobile supply machine 19 comprises a material dump 23 for transferring installation material. The material dump 23 is tiltable. The mobile supply machine 19 comprises an energy storage 24, which is replaceable and chargeable. The energy storage 24 can be arranged in an energy storage module 25, which comprises several energy storage 24. The energy storage 24 or the energy storage module 25 is attached, for example, to a passenger position 26 of the driver's control station 20, so that the energy storage 24 can be easily accessed and replaced from a passenger entry direction (opposite a direction of travel R1 of the mobile supply machine 19).

FIG. 4 shows a schematic representation of a paving train 27, in this specific embodiment comprising the road construction machine 1 in the form of the road finisher 2 or the feeder vehicle 18 and the mobile supply machine 19. The paving train 27 is movable in a direction of travel R of the road finisher 2. The mobile supply machine 19 is slowly driven backwards (against the direction of travel R) towards the road construction machine 1 and docked when the road construction machine 1 is supplied with paving material and/or electrical power.

An (electrical) charge level 29 of the energy storage E, E′ of the road construction machine 1 is monitored via a control system 28 of the road construction machine 1. If the charge level 29 is between twenty percent and ninety percent, electrical power is fed to the energy storage E, E′ of the road construction machine. As those skilled in the art will understand, the control system 28, as well as any other controller, control, unit, component, module, system, subsystem, interface, element, machine, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, steps, functions and/or operations described herein, including interaction between and/or cooperation with each other. One or more of such processors, as well as other circuitry and/or hardware, may be included in a single Application-Specific Integrated Circuit (ASIC), or several processors and various circuitry and/or hardware may be distributed among several separate components, whether individually packaged or assembled into a System-on-a-Chip (SoC).

The road construction machine 1 comprises a first interface 15a at a docking end 30 or at the coupling device 13, 13′. The first interface 15a is an electromechanical unit suitable for electrical power transmission. The first interface 15a, or electromechanical unit of the road construction machine 1 comprises a first opening 31 for receiving a connecting unit 32, or a first connecting unit 32a of the mobile supply machine 19 for electrical energy transmission. The first connecting unit 32a is an electromechanical unit. The first connecting unit 32a is arranged on a docking side 33, or on a discharge end 34, of the mobile supply machine 19. When the first connecting unit 32a is connected to the first interface 15a, electrical power is transferred from the energy storage 24 of the mobile supply machine 19 to the road construction machine 1.

FIG. 5 shows a schematic representation of the paving train 27 in a docking state 35, or energy transfer state, in which the mobile supply machine 19 is docked to the road construction machine 1. In this position, the mobile supply machine 19 is mechanically and electrically connected to the road construction machine 1. During docking, the docking elements 14, 14′ are pressed against the tires (not shown) of the mobile supply machine 19. In the docking state 35, the energy storage E, E′ of the road construction machine 1 is electrically charged. Furthermore, the first interface 15a of the road construction machine 1 is mechanically connected to the first connecting unit 32a of the mobile supply machine 19. This makes it possible for the approaching road construction machine 1 to displace the mobile supply machine 19 in the direction of travel R.

The energy storage E, E′ of the road construction machine 1 is connected to the first interface 15a of the road construction machine 1 via a first power supply path 36.

Two separate power supply paths 37, 38 lead away from the energy storage E, E′ of the road construction machine 1. In a second power supply path 37, the energy storage E supplies the electric motor 3a, 3a′ of the road construction machine 1. In a third power supply path 38, the energy storage E, E′ of the road construction machine 1 directly supplies the electrical load 11, 11′ of the road construction machine 1 with power.

The first connecting unit 32a of the mobile supply machine 19 is connected to the energy storage 24 of the mobile supply machine 19 via a fourth power supply path 39.

In the docking state 35, it is also possible to bring the material dump 23 of the mobile supply machine 19 into a tilting state and to load the material hopper 7, 7′ of the road construction machine 1 with paving material B, B′ (not shown).

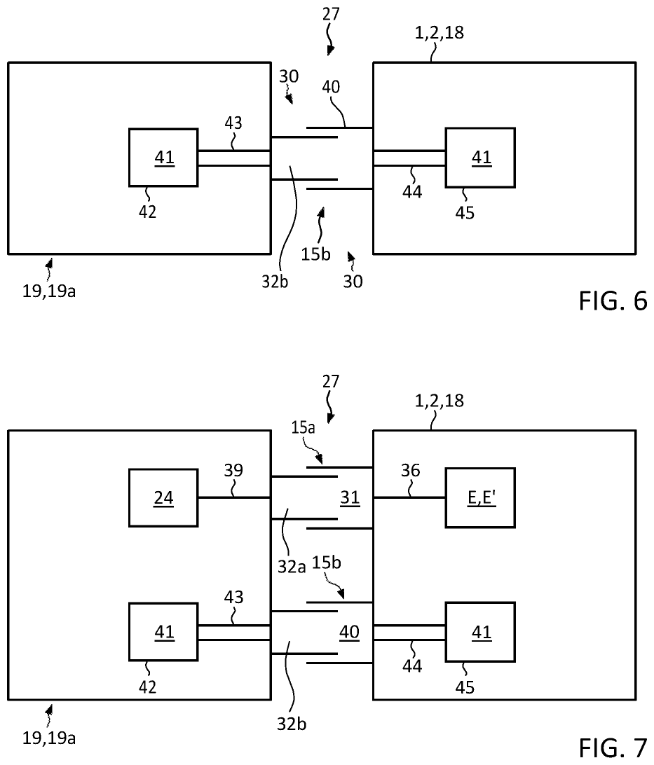

FIG. 6 shows the paving train 27 in another embodiment. The road construction machine 1 comprises a second interface 15b at the docking end 30, or at the coupling device 13, 13′. The second interface 15b comprises a receptacle or second opening 40 for receiving energy resources 41 as well as fuel, diesel, natural gas, hydrogen or liquids required for operating the galvanic cells, from the mobile supply machine 19. The mobile supply machine 19 comprises a second connecting unit 32b for transferring energy resources 41 to the road construction machine 1. The second connecting unit 32b is an electromechanical unit, which may comprise a receptacle, mouth, opening, conduit, tube, or pipe. The second connecting unit 32b is arranged on the docking side 33, or on the discharge end of the mobile supply machine 19. The energy resource 41 is transported from the mobile supply machine 19 to the road construction machine 1 when the mobile supply machine 19 is in the docking state 35. The second interface 15b is connected to the second connecting unit 32b to transfer energy resource 41 from the mobile supply machine 19 to the road construction machine 1. Energy resource 41 is fed from an energy resource container 42 of the mobile supply machine 19 to the second connecting unit 32b via a pipe 43. Energy resource 41 is fed to an energy resource tank 45 of the road construction machine 1 via a line (tube) 44.

FIG. 7 shows the paving train 27 in another embodiment. In this embodiment, the road construction machine 1 comprises two interfaces at the docking end 30, or at the coupling device 13, 13′, the first interface 15a for transferring energy from the mobile supply machine 19 and the second interface 15b for transferring energy resources 41 from the mobile supply machine 19. Accordingly, the mobile supply machine 19 comprises the first connecting unit 32a and the second supply unit 32b. The operation of these units is explained above.

What is claimed is:

1. A road construction machine formed as a road finisher or a feeder vehicle for conveying paving material to a road finisher, wherein the road construction machine is self-propelled and comprises a primary drive, a material hopper, at least one electrical load, at least one energy storage, and at least one interface which is connectable to a mobile supply machine for energy transmission or energy resources transmission.

2. The road construction machine according to claim 1, wherein the road construction machine is loadable with paving material by the mobile supply machine.

3. The road construction machine according to claim 1, wherein the road construction machine is connectable to the mobile supply machine via a first interface for the transmission of electrical power.

4. The road construction machine according to claim 1, wherein the road construction machine is connectable to the mobile supply machine via a second interface for the transmission of energy resources comprising fuel, diesel, natural gas, hydrogen or liquids required to operate the galvanic cells.

5. The road construction machine according to claim 3, wherein the first interface and/or the second interface are arrangeable at a docking end of the road construction machine, the docking end comprising a pushing device of the road construction machine.

6. The road construction machine according to claim 3, wherein the road construction machine is mechanically connectable to the mobile supply machine via the first interface and/or via the second interface, such that the road construction machine can transmit force to the mobile supply machine.

7. The road construction machine according to claim 3, wherein the first interface and/or the second interface each has an opening for receiving a connecting unit of the mobile supply machine.

8. A paving train comprising at least one road construction machine formed as a road finisher or a feeder vehicle for conveying paving material to a road finisher, wherein the road construction machine is self-propelled and comprises a primary drive, a material hopper, at least one electrical load, at least one energy storage, and at least one interface, wherein the paving train further comprises a mobile supply machine with at least one connecting unit, and wherein each of the at least one interface of the road construction machine is connectable to one of the at least one connecting unit of the mobile supply machine for energy transmission or energy resources transmission.

9. The paving train according to claim 8, wherein the mobile supply machine is a material supply vehicle for supplying paving material.

10. The paving train according to claim 8, wherein the interface and the connection unit are electromechanical units that mate together.

11. The paving train according to claim 8, wherein a first interface and a first connecting unit are connectable to each other for transmitting electrical power.

12. The paving train according to one of claim 8, wherein a second interface and a second connecting unit are connectable to each other for the transmission of energy resources comprising fuel, diesel, natural gas, hydrogen, or liquids required to operate the galvanic cells.

13. A method for operating a paving train comprising at least one road construction machine formed as a road finisher or a feeder vehicle for conveying paving material to a road finisher, wherein the road construction machine is self-propelled and comprises a primary drive, a material hopper, at least one electrical load, and at least one energy storage, wherein the paving train comprises a mobile supply machine with a material dump for supplying paving material to the road construction machine, the method comprising:
connecting an interface of the road construction machine to a connecting unit of the mobile supply machine for transferring electrical power or energy resources to the road construction machine from the mobile supply machine.

14. The method according to claim 13 further comprising:
monitoring a charge level of the energy storage of the road construction machine; and
transmitting electrical power from the mobile supply machine to the road construction machine when the charge level is between twenty percent and ninety percent.

15. A method for energy transmission and/or energy resources transmission comprising using an interface of a road construction machine for electromechanical coupling with a connecting unit of a mobile supply machine.
